(19) United States
(12) Patent Application Publication
(10) Pub. No.: US 2015/0060090 A1
(43) Pub. Date: Mar. 5, 2015

(54) SYSTEM AND METHOD FOR DISTRIBUTION OF A LIQUID USING REMOTE CONTROLLED HOVERCRAFT

(71) Applicant: LEE HARRIS, MADISON, GA (US)

(72) Inventor: LEE HARRIS, MADISON, GA (US)

(21) Appl. No.: 14/475,697

(22) Filed: Sep. 3, 2014

Related U.S. Application Data
(60) Provisional application No. 61/873,658, filed on Sep. 4, 2013.

(51) Int. Cl. A62C 3/02; A62C 31/00

(52) U.S. Cl. CPC A62C 3/0242; A62C 31/00
USPC 169/13

(57) ABSTRACT

Various embodiments, aspects and features of the present invention encompass a system and/or a method for fighting fires that leverages the use of one or more hovercraft components generally referred to in this specification as “tethercraft.” Generally, embodiments of the tethercraft system include a pumping station applied to a water source and tethered to one or more tethercraft components. Advantageously, the tethercraft components may be remotely controlled to target specific areas of the fire by dispensing water and/or fire retardant chemicals.

### CROSS-REFERENCE TO RELATED APPLICATIONS

This application claims priority under 35 U.S.C. §119(e) to U.S. provisional application entitled “SYSTEM AND METHOD FOR DISTRIBUTION OF A LIQUID USING REMOTE CONTROLLED HOVERCRAFT,” filed on Sep. 4, 2013 and assigned application Ser. No. 61/873,658, the entire contents of which are hereby incorporated by reference.

### BACKGROUND

The present invention relates to a liquid distribution system and method and, more particularly, to a system and method that leverages remotely controlled hovercraft to distribute pressurized water and/or fire retardant to fight fires. Although the present embodiments are primarily described within the context of fire fighting, the embodiments are not limited to fire fighting applications. It is envisioned that certain embodiments may be suited for remote distribution and application of chemicals on crops (such as pesticides, fungicides, etc.), remote intelligence gathering, remote placement of objects, etc.

At present, systems and method for fighting fires, particularly forest fires, are inadequate. The use of large helicopters to transport “buckets” of water dipped from a nearby lake, for instance, provides limited ability to control where and how much water is applied to the fire. As a result, the water may be inefficiently used due to poor timing in the release of the water from the bucket or may be wasted by being dumped on an area of the fire that is under control or does not require a large volume of water to be extinguished. Other methods for fighting fires necessarily require that firefighters be in close proximity with the fire, which may place the firefighters in danger of physical harm.

Therefore, what is needed in the art is a system and method for fighting fires that makes efficient use of a water supply and/or fire retardant and alleviates the need for firefighters to be in close physical proximity with the fire.

### BRIEF SUMMARY

Various embodiments, aspects and features of the present invention encompass a system and/or a method for fighting fires that leverages the use of one or more hovercraft components generally referred to in this specification as “tethercraft.” Generally, embodiments of the tethercraft system include a pumping station applied to a water source and tethered to one or more tethercraft components. Advantageously, the tethercraft components may be remotely controlled to target specific areas of the fire by dispensing water and/or fire retardant chemicals.

Certain embodiments of a tethercraft system may be truck-based and useful for short-range applications. The truck may be outfitted with a reservoir for holding a volume of water or fire retardant. Connected to the reservoir may be a pumping system driven by a local generator or other power source, as would be understood by one of ordinary skill in the art. The pumping station may be operable to pump water from the reservoir through a hose component (i.e., a “tether”) that may be rolled on a reel that also resides on the truck. The tether may be connected to one or more tethercraft components that are operable to release the water pumped from the pumping station and through the tether. Depending on embodiment, one or more of the tethercraft components may be remotely controlled by one or more onboard propellers driven by a local electrical motor or may be remotely controlled by on board turbines driven by the pressurized water received from the tether before being exhausted onto a fire. In some embodiments, a tethercraft component may be positionally controlled by turbines driven by pressurized water or other hydraulic fluid which recirculates back through a recirculation pump. It is envisioned that the pumping system may be configured to pump water from a local water source other than a reservoir that resides on the truck.

Another embodiment of a tethercraft system may be configured for long-range applications. A long-range tethercraft system may include a pump station (could be truck-mounted) specifically configured for pumping from a large water source, such as a lake or other body of water near a fire. An anchor/lift component in the form of a blimp or helicopter may be tethered between the pump station and one or more tethercraft components. It is envisioned that, depending on the embodiment, the lift component may not only provide lift to the tether hose but also include a reservoir to which the pumping station may pump. In such embodiments, the anchor point component may include its own pumping station for pumping water from the reservoir to the remotely controlled tethercraft components. Other embodiments may use a gravity feed for delivering water from a reservoir to one or more tethercraft components, as would be understood by one of ordinary skill in the art.

### BRIEF DESCRIPTION OF THE SEVERAL VIEWS OF THE DRAWING

FIG. 1 is a functional block diagram of a short-range tethercraft system for fighting fires.

FIG. 2 is a functional block diagram of a long-range tethercraft system for fighting fires.

### DETAILED DESCRIPTION

Embodiments and aspects of the present invention provide a solution to the above-described need in the art, as well as other needs in the art by providing a system and method for remote distribution of a liquid through remote controlled tethercraft.

One aspect or purpose of the present invention is to alleviate the need for firefighters to be in close physical proximity with a fire. To accomplish this goal, embodiments of a tethercraft system leverage a pumping station in communication through a tether hose to one or more remotely controlled tethercraft.

It is envisioned that tethercraft components may include spray nozzles, misting nozzles, infrared cameras, video cameras, protective aspects (Kevlar shields, etc.), turbines (air driven or water driven), control circuitry including electric motors, solenoid valves, rudders/flaps, jets, etc. Certain embodiments of tethercraft components may have one or more water-driven turbines for providing lift and/or one or more adjustable turbines or propellers for providing directional adjustment. Some embodiments may exhaust water through the turbine for application on a fire. Other embodiments may comprise a separate nozzle with water supply line in the tether for spraying water on a fire.

It is also envisioned that a tether hose or hoses used in a given embodiment of a tethercraft system may comprise four sections plus a fiber optic/control wire conduit. The four sections may be used thusly, depending on embodiment: 2 for powering tethercraft components via high pressure water supplied to tandem turbines, 1 for recirculation of the water supplied to the turbines and 1 for fire retardant injection. Fiber optic or other control wires may also be included in a given tether hose to provide a means for sending and receiving control signals from control circuits residing within a given tethercraft component. Notably, it is envisioned that a given tethercraft component may be controlled by electronic signals to a electrically driven motor, air signals to an air driven motor (if tether hose includes a high pressure air line supplied by compressed air) or pressurized water. Further, although a particular tether hose configuration may be novel in and of itself, a tethercraft system covered by this specification is not limited to include any particular tether hose arrangement.

Turning now to the figures, where like labels represent like elements throughout the drawings, various aspects, features and embodiments of exemplary tethercraft systems and methods will be presented in more detail. The examples as set forth in the drawings and detailed description are provided by way of explanation and are not meant as limitations on the scope of a tethercraft system for remote distribution of water and/or fire retardant on a fire. A tethercraft system and method thus includes any modifications and variations of the following examples as come within the scope of the appended claims and their equivalents.

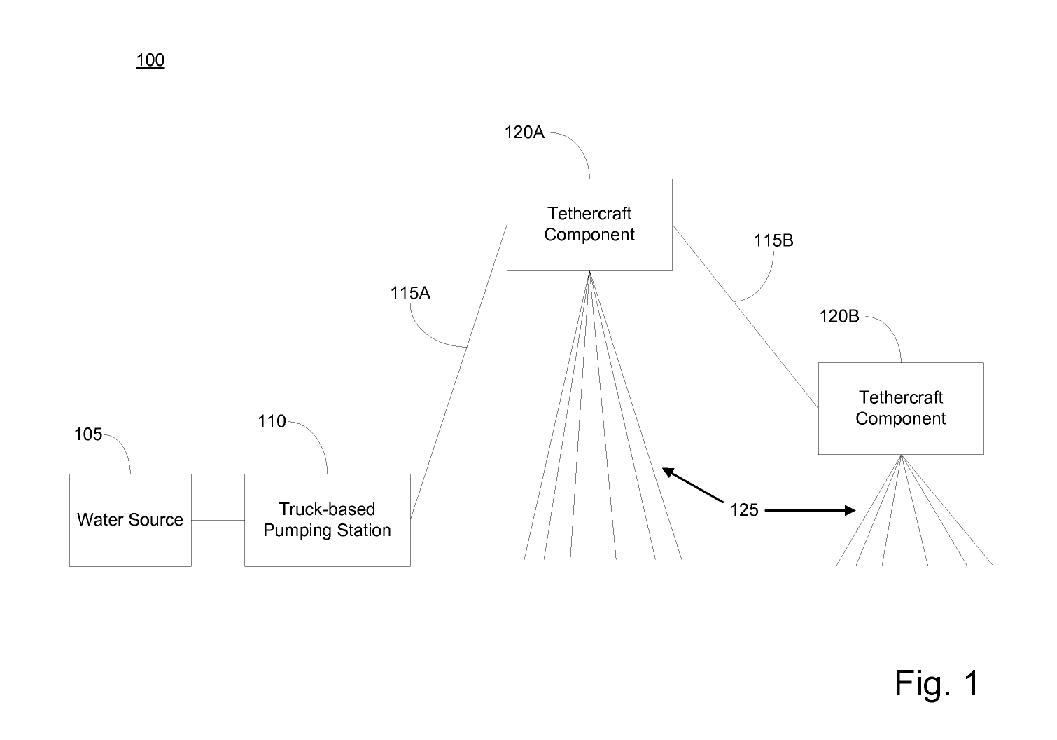

FIG. 1 is a functional block diagram of a short-range tethercraft system 100 for fighting fires. The system 100 includes a water source 105 which, depending on embodiment, may be a local water source such as a pond or water hydrant or may be a reservoir/tank that resides on a truck or mobile platform. The truck or mobile platform is depicted in FIG. 1 as the truck-based pumping station 110. Advantageously, the tethercraft system 100, being packaged on a truck or mobile platform, can be deployed to a fire.

The truck-based pumping station 110 may be connected to tethercraft components 120 via tethers 115. Notably, tether 115A may include a boom or other mechanical support structure that is anchored at the truck-based pumping station 110 so that the tether 115A may be supported above the ground, although it is envisioned that not all embodiments of a system 100 may include a boom. As explained above, the tethers 115 may include a series of tubes in a common bundle for accommodating flow of water or other fluid from the pumping station 110 to the tethercrafts 120. The tethers 115 may also include conduits for control wires or other electrical signal and/or data communication wires, such as fiber optics. It is also envisioned that a tethercraft 120 may include spray nozzles for spraying water and/or fire retardant, propellers and fins for steering the tethercraft, turbines, infrared cameras, video cameras, temperature sensors, etc.

Advantageously, the tethercraft 120A and 120B may be remotely controlled by an operator located at or near the truck-based pumping station 110 using a control station communicatively coupled to the tethercraft 120 through the tethers 115, as would be understood by one of ordinary skill in the art. Water or fire retardant 125 may be accurately and efficiently dispensed from the tethercraft 120.

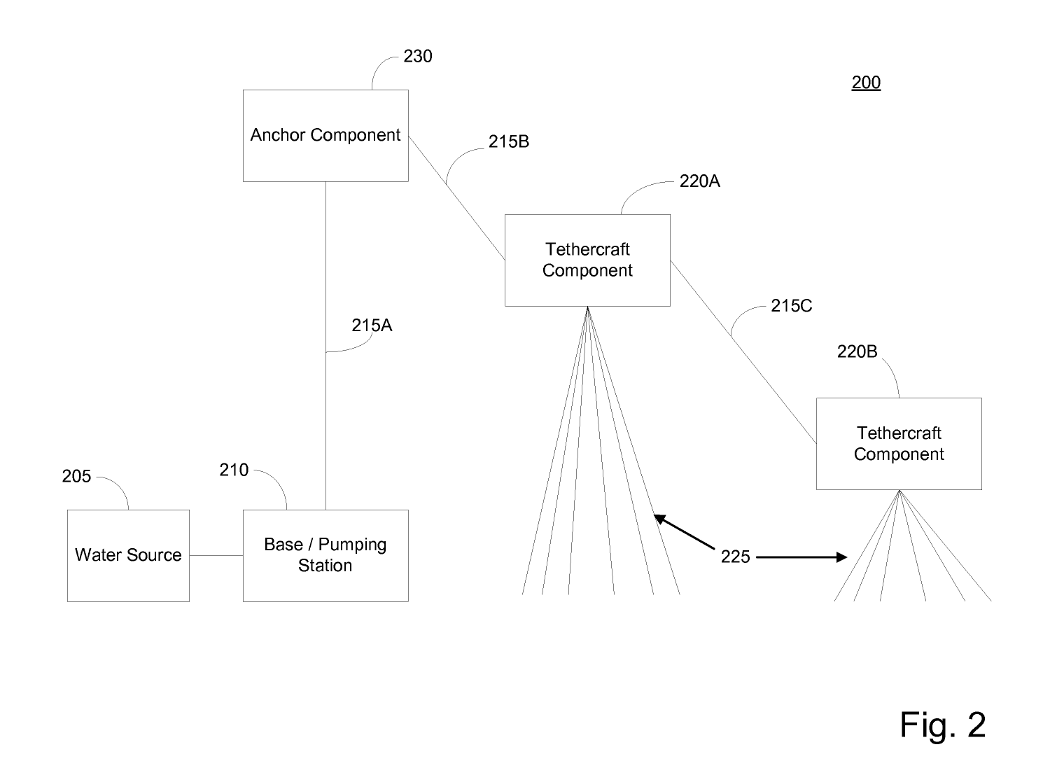

FIG. 2 is a functional block diagram of a long-range tethercraft system 200 for fighting fires. The various components of the system 200 are envisioned to be similar to that which has been described above relative to the system 100. A base pumping station 210 may pump from a water source 205. It is envisioned that a long-range tethercraft system 200 may be configured for deployment to remote fires such as, for example, forest fires. The base/pumping station 210 may be an airlifted skid or may be mounted on a mobile platform such as a truck bed. The base pumping station 210 may include one or more pumps for pumping water from the water source 205 through the tethers 215 and to the tethercraft components 220. The base pumping station 210 may also include a generator and associated instrumentation, as would be understood by one of ordinary skill in the art.

The base pumping station 210 may be connected via tether 215A to an anchor component 230 such as, but not limited to, a helicopter, a blimp, a balloon, etc. It is envisioned that the anchor component 230 may provide lift to the system 200 so that tethers 215B and 215C and tethercraft 220 may be safely maintained at an altitude above the fire and/or above a tree canopy level. The anchor component 230 may also include a reservoir for holding a volume of water pumped to it by the pumping station 210. From the anchor point 230, water and control signals and data communications are transmitted to and from the tethercraft 220A and 220B via the tethers 215B and 215C. Notably, it is envisioned that certain embodiments of a tethercraft system 100 or 200 may include more or less components than are depicted in the drawings and, as such, the figures are not meant to limit the scope of the disclosure.

The tethercraft 220 may include any or all of the features described above relative to tethercraft 120. Advantageously, the positioning of the tethercraft 220 may be remotely controlled by an operator in communication with the tethercraft 220 through data channels embedded in the tethers 215. Positioning feedback, such as GPS data, and video feedback from the tethercraft 220, such as video or infrared imaging, may be used by the operator to accurately position the tethercraft 220 over a fire and release water or fire retardant 225 to extinguish the fire. It is envisioned that the operator may be located at or near the base pumping station 210 or anywhere so long as the operator is in communication with the system 200, as would be understood by one of ordinary skill in the art of telecommunications, satellite communications, Internet communications, etc.

Various aspects, features and characteristics of the present invention have been described. Not all of the aspects, features or characteristics are required for each and every embodiment of the present invention. However, it will be appreciated that the various aspects, features, characteristics and combinations thereof may be considered novel in and of themselves. Further documentation in support of the description detailed herein is appended to this application.

What is claimed is:

1. A system for applying water to a fire from a remote location, the system comprising:
a pumping station;
a control module; and
one or more tethercraft components connected to the pumping station and controlled by the control module, wherein the tethercraft components are connected to the pumping station and control module by one or more tethers that include a control wire conduit and at least one channel for transmitting pressurized water from the pumping station to the one or more tethercraft components.
